(19) United States
(12) Patent Application Publication
(10) Pub. No.: US 2012/0150951 A1
(43) Pub. Date: Jun. 14, 2012

(54) COMPUTER SYSTEM, RECORDING MEDIUM AND MAINTENANCE SUPPORT SYSTEM

(75) Inventors: Hideaki Ito, Tokyo (JP); Hirofumi Danno, Yokohama (JP); Atsushi Sashino, Yokohama (JP)

(73) Assignee: Hitachi, Ltd, Tokyo (JP)

(21) Appl. No.: 13/390,863

(22) PCT Filed: Mar. 16, 2011
(86) PCT No.: PCT/JP2011/001523

§ 371 Date: Feb. 16, 2012

(30) Foreign Application Priority Data
Mar. 17, 2010 (JP) 2010-060122
Jul. 22, 2010 (JP) 2010-164433

(51) Int. Cl. G06F 15/16

(52) U.S. Cl. 709/203; 709/224

(57) ABSTRACT

An aspect of the invention is a system for acquiring execution information of a process executed in a computer which receives an execution request of a process and a request to start acquiring execution information of the process from a client. An application execution part of a server part executes the process based on the execution request. An execution information acquirement control part of the server part stores execution information of the process executed by the application execution part in a storage device based on the request to start acquiring execution information. The stored execution information is displayed in response to a display request.

### CLAIM OF PRIORITY

The present application claims priority from Japanese patent application JP2010-060122 filed on Mar. 17, 2010 and Japanese patent application JP2010-164433 filed on Jul. 21, 2010, the contents of which are hereby incorporated by reference into this application.

### BACKGROUND OF THE INVENTION

The present invention relates to a system, a recording medium and a maintenance support system, and particularly to a system for acquiring execution information of a process in a computer, a recording medium storing a program for causing the system to execute the process and a maintenance support system.

In a life cycle of an information system, a person in charge of the information system comes across a situation where a large number of man-hours have to be invested to understand the operation of the information system. Particularly, a person in charge of maintenance/improvement by adding a function to the information system in a maintenance phase and carrying out a task such as dealing with a correction in the event of a trouble has to invest man-hours in analyzing a cause of the trouble of the information system due to problems such as obsolescence of a design document caused by repeated corrections and complexity of a source code in some cases.

To understand the operation of an information system, a technology for generating specification information such as a class/method call relationship is thought to support the work of a person in charge of the information system. For example, Patent literature 1 discloses a method for hierarchizing analysis information of a source code of software to be analyzed and successively storing it in a recording medium such as a database to support a reduction of cumbersome works of the person in charge associated with software analysis such as having to carry out an analysis again after taking a certain measure such as when a memory capacity in a computer system to be analyzed is insufficient.

Further, conventionally, there has been a method for manually extracting related information from various individually output logs (web server log, task application log, database access log, etc.) based on temporal proximity and attempting to understand the operation of an information system and analyze a cause of a trouble in a server. Such a method often requires a great deal of time and efforts. Particularly, in Patent literature 2, a method for generating dynamic design information such as a sequence diagram from execution sequence information acquired by analyzing a source code and internally executing a program is cited as a method for understanding the operation of the program. Further, since the above logs are constantly output, they place a burden on a hard disk and a great deal of time is required in manually analyzing the logs due to a huge volume of data. In Patent literature 3, a function capable of reading information described in a source code (e.g. as a comment) in advance at a server side and customizing whether or not to acquire an input operation of a candidate to be acquired is realized to reduce the recording volume of a screen input operation history of a web application.

### CITATION LIST

Patent literature 1: Japanese Patent No. 3997495
Patent literature 2: JP2008-310679A
Patent literature 3: JP2009-25977A

### SUMMARY OF THE INVENTION

In the case of Java language, there are cases where an operation is not determined until a program is executed. Information obtained by statically analyzing a source code as in Patent literature 1 alone may be insufficient to understand the operation of a program.

In a web application having a characteristic that a plurality of users can simultaneously access to a server using client PCs and use the same program and other characteristics, the operation of the web application cannot be understood only by using dynamic design information of the program (in the server) mentioned in Patent literature 2 and it is also necessary to match data operation contents on a request transmitter page, a database (hereinafter, abbreviated as DB) with the above execution information of the program and visualize them as a series of operations.

Further, in Patent literature 2, it takes time to decipher a source code in advance to set information (e.g. parameter transmitted by a form tag of an HTML file) necessary for an event to be executed.

Further, there is no method for selectively acquiring information at the time of execution without reconfiguring a source code. A means for selecting information to be acquired at the time of execution at a server side based on information added to a source code is thought as in Patent literature 3, but it is necessary to compile the source code and reallocate a web application each time in the case of correcting information added to the source code such as addition of a candidate for an input operation acquired at the time of execution.

In view of the situation described above, a main object of the present invention is to control the output of information system internal information based on information included in a request from the outside such as a client.

In order to solve the problems, an aspect of the invention is a system for acquiring execution information of a process executed in a computer, including: a client part for issuing an execution request for a process; and a server part including an application execution part for executing a process according to an execution request from the client and an execution information acquirement control part for controlling acquirement of execution information. The client part receives and stores a request to start acquiring execution information. The client part transmits a request to acquire execution information to the server part together with an execution request based on the stored request to start acquiring execution information upon receiving the execution request for the application execution part after receiving the request to start acquiring execution information. The application execution part executes a process based on the execution request. The execution information acquirement control part stores execution information of the process executed by the application execution part in a storage device based on the request to acquire execution information.

In maintenance and improvement of an information system, it is possible to dynamically acquire execution time information of web applications and enable a user himself to determine the start and end of acquirement of the execution time information. This contributes to a reduction of lead time to investigate a cause in the event of a trouble and to understand the existing information system.

### BRIEF DESCRIPTION OF THE DRAWINGS

FIG. 1 shows a configuration example of a system according to an embodiment to which the present invention is applied,

FIG. 2 shows an example of a hardware configuration of a server,

FIG. 3A is a flow diagram showing an execution time information acquiring process in a client,

FIG. 3B is a flow diagram showing an execution time information reference process in the client,

FIG. 4 is a diagram showing examples of an execution time information acquirement information setting page P001 and a task page P002,

FIG. 5 is a diagram showing an example of execution time information acquirement information C001,

FIG. 6 is a diagram showing an example of an execution time information reference page P003 displaying a list of “record IDs”,

FIG. 7 is a diagram showing an example of an execution time information reference page P004 displaying a list of “request IDs”,

FIG. 8 is a diagram showing the configuration of a memory (main storage device 202) in a server 120 in the execution time information acquiring process,

FIG. 9 is a diagram showing an example of an execution time information acquirement target list 171,

FIG. 10 is a diagram showing a process flow in the server 120 in the execution time information reference process,

FIG. 11 is a diagram showing an example of execution time information stored in a request execution time information file 143a,

FIG. 12 is a diagram showing an example of execution time information stored in a program execution time information file 143b,

FIG. 13 is a diagram showing an example of execution time information stored in a DB access execution time information file 143c,

FIG. 14 is a diagram showing the module configuration of an execution time information reference program 133,

FIG. 15 is a diagram showing a process flow of modules constituting the execution time information reference program 133,

FIGS. 16A to 16C show an example of execution time information extracted by an execution time information display data acquiring module 1402,

FIGS. 17A and 17B illustrate a diagram showing a process flow in an execution time information display module 1403, and

FIG. 18 is a diagram showing an example of a screen 1800 to be displayed by the execution time information display module 1403.

### DETAILED DESCRIPTION OF THE EMBODIMENTS

Hereinafter, an embodiment of the invention is described.

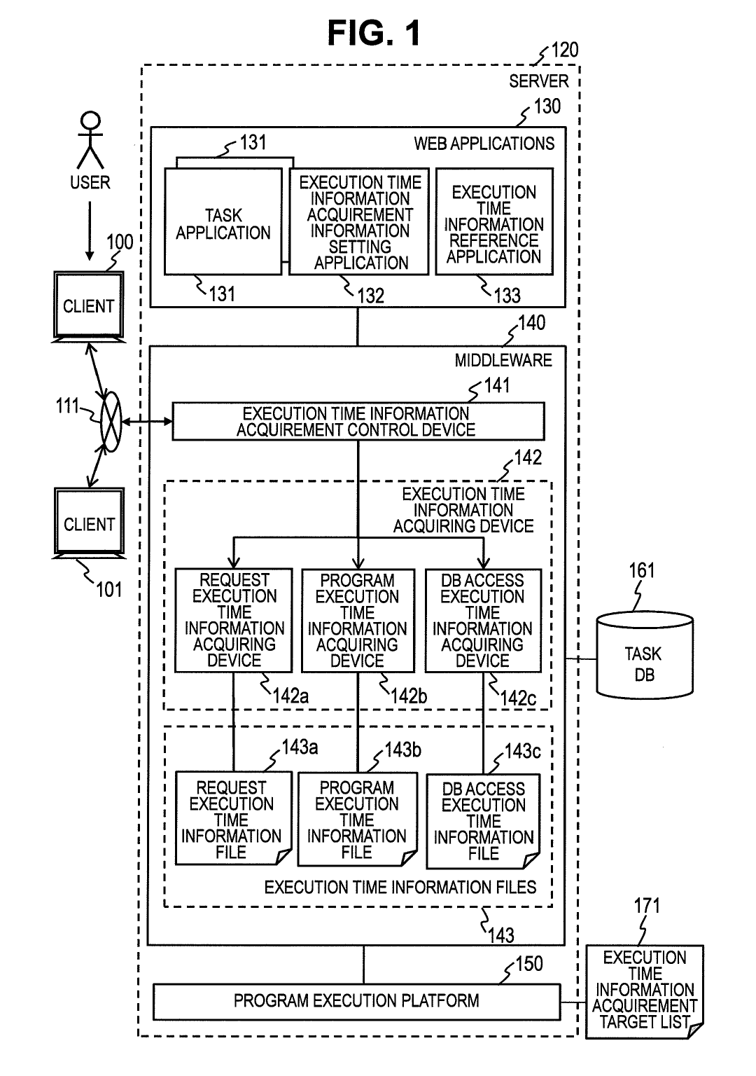

FIG. 1 shows a configuration example of a maintenance support system as one embodiment to which the present invention is applied. In the maintenance support system, a client 100, a client 101 and a server 120 coordinated via a network 111 build a client/server configuration. Note that functions corresponding to a plurality of clients and a server may be allocated on the same computer by software.

Note that only the client 100 is described below to simplify the description.

In the system, concerning acquirement of information at the time of executing a web application, it is controlled to acquire execution time information for each user or each request of the web application.

The server 120 includes web applications 130, middleware 140 and a program execution platform 150. The substance of these web applications 130, middleware 140 and program execution platform 150 is software of the server 120 to be described later and realized by a CPU 201 of the server 120 reading software stored in an external storage device 204 into a main storage device 202 and executing it.

The web applications 130 indicate a set of applications allocated on the server 120. In this embodiment, the allocated web applications 130 include a task application 131, an execution time information acquirement information setting application 132, and an execution time information reference application 133. Note that a plurality of task applications may be allocated as the task application 131.

The execution time information acquirement information setting application 132 has a function of adding/updating execution time information acquirement information C001 to a request transmitted to the server from the client.

The execution time information reference application 133 has a function of referring to the recorded execution time information.

The middleware 140 includes an execution time information acquirement control device 141, an execution time information acquiring device 142 and execution time information files 143. The substance of the execution time information acquirement control device 141 and the execution time information acquiring device 142 is also software allocated on the middleware 140.

The execution time information acquirement control device 141 has a function of referring to the execution time information acquirement information added to a request transmitted from the client 100 via the network, and instructing the execution time information acquiring device 142 to start/stop acquiring the execution time information. The execution time information acquirement control device 141 also has such a function of transferring a received request to an application represented by an application server.

The execution time information acquiring device 142 acquires information at the time of executing the web application 130 allocated on the server 120. Although the execution time information acquiring device 142 includes a request execution time information acquiring device 142a, a program execution time information acquiring device 142b and a DB access execution time information acquiring device 142c in this embodiment, the configuration thereof is not limited to this.

The request execution time information acquiring device 142a has a function of acquiring information (request target URL, data input in a client PC, etc.) of a request transmitted from the client PC.

The program execution time information acquiring device 142b has a function of acquiring information on a program call relationship read into the main storage device 202 for the substance of the web applications 130 stored in the external storage device 204 by the program execution platform 150. For example, in the case of a web application written in Java language, a call relationship such as information on the package name, class name and method name of a caller object and those of a call target object is acquired for an object allocated to the main storage device 202 by JavaVM.

The DB access execution time information acquiring device 142c has a function of referring to/updating data in the DB in accordance with an SQL sentence issued by the web application 130 and a function of acquiring information such as in referring to/updating the data in the DB. For example, an SQL sentence issued by the web application 130 for a task DB 161, the value of data acquired by referring to a table of the task DB 161 and the like can be obtained.

The execution time information files 143 are files for storing the execution time information acquired in the execution time information acquiring device 142. In this embodiment, the execution time information files 143 include a request execution time information file 143a, a program execution time information file 143b and a DB access execution time information 143c. The execution time information files 143 may be mounted in the external storage device 204 of the server machine 120 to be described later or may be mounted in another storage device connected to the server machine 120. Further, a storage destination of the execution time information may be DBs and the like in addition to the files.

The program execution platform 150 has a function of inserting a machine code used to acquire the execution time information in reading the substance of the web applications 130 into the main storage device 202. For example, if the program execution platform 150 is JavaVM, a java.lang.instrument package is known and a function of embedding an arbitrary byte code is provided in instantiating a class file and allocating an object on a memory.

The task DB 161 is a database for the task application 131. The task DB 161 may be mounted in the external storage device 204 of the server 120 to be described later or may be mounted in another storage device connected to the server 120.

An execution time information acquirement target list 171 is a list of the names of recorded programs for which the execution time information is to be acquired. Although the execution time information acquirement target list 171 is stored in a file in this embodiment, there is also a method for storing it in a DB or the like. The execution time information acquirement target list 171 may also be mounted in the external storage device 204 of the server 120 to be described later or may be mounted in another storage device connected to the server 120.

The respective constituent elements are described in detail below.

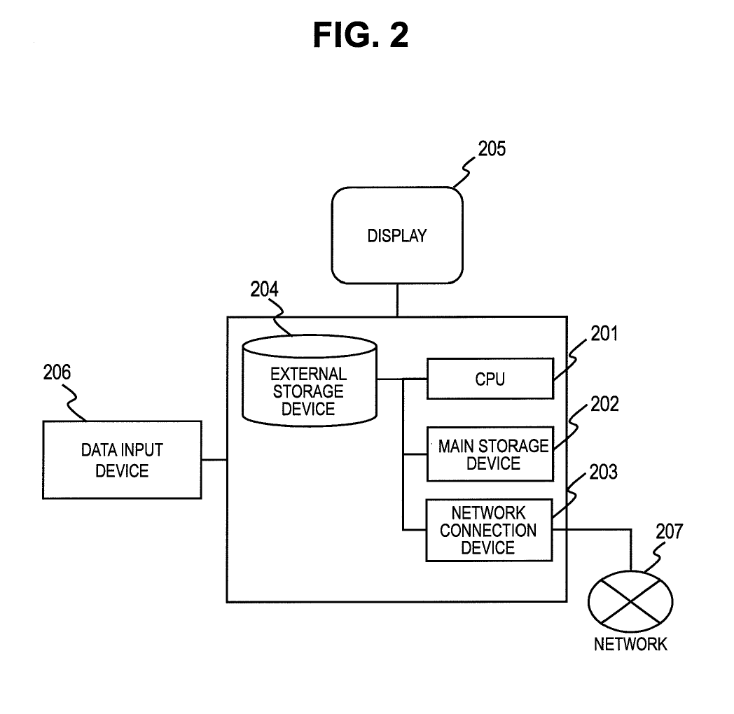

FIG. 2 shows an example of a hardware configuration of the server 120.

The server includes the CPU 201, the main storage device 202, a network connection device 203, the external storage device 204, a display 205, a data input device 206, the network 207 and the like. Note that the client PC 100 also has a hardware configuration similar to that of the server 120.

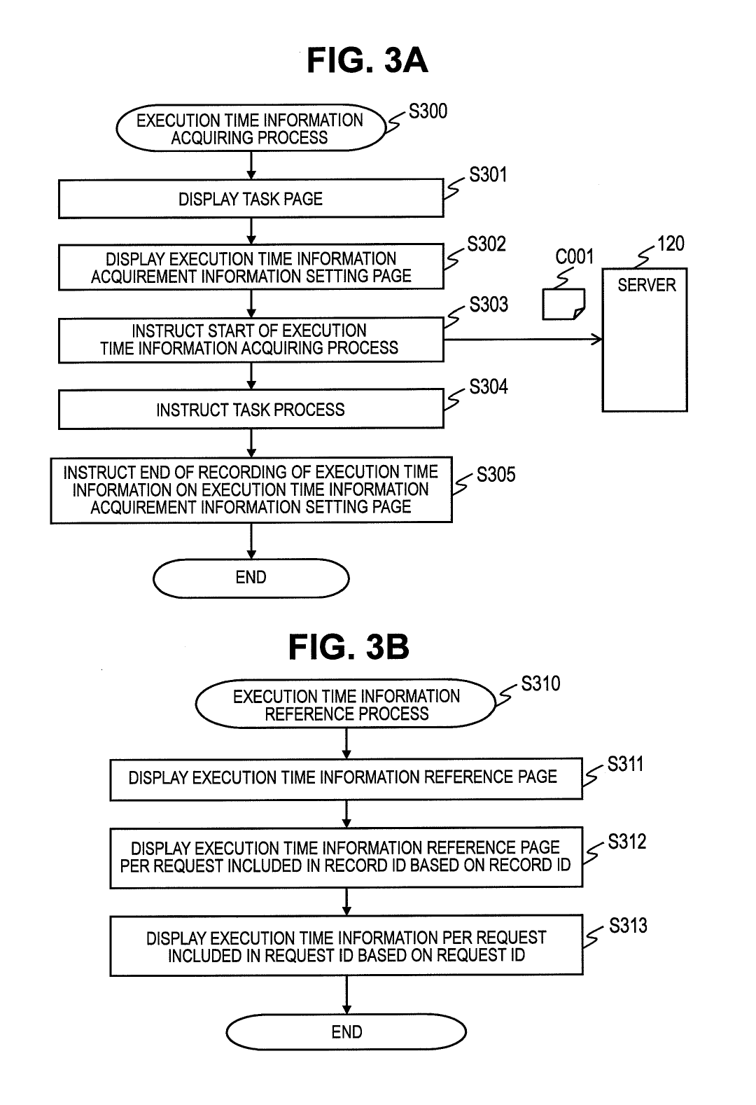

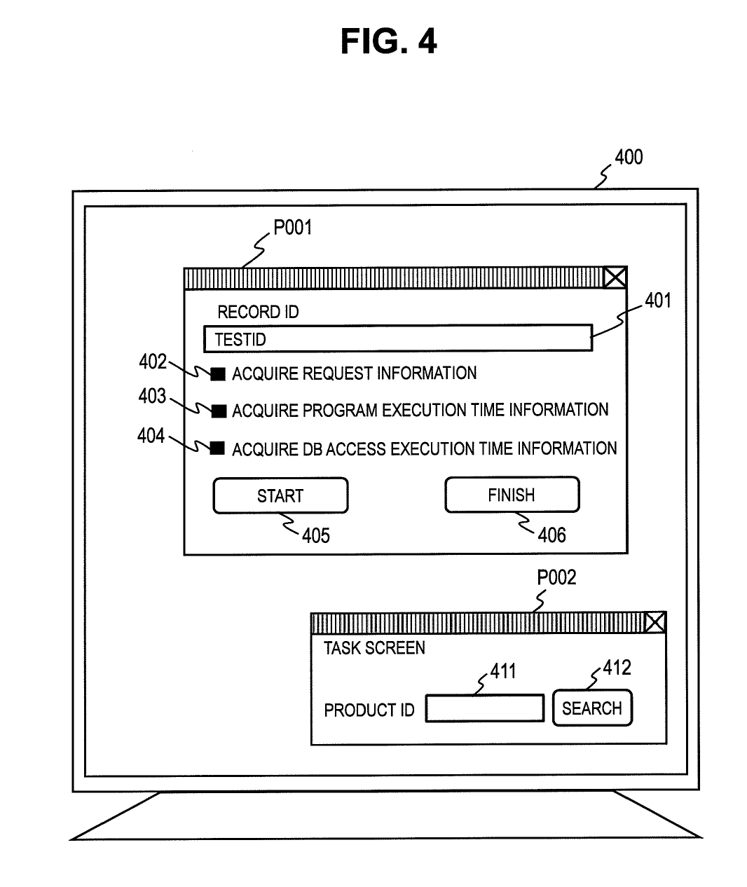

FIG. 3 shows the flow of a process executed by the client 100 via an input operation and the like from a “user”. Here, FIG. 3A shows the flow of an execution time information acquiring process S300 of storing the execution time information of the task application 131, and FIG. 3B shows an execution time information reference process S310 of referring to the execution time information of the task application 131 recorded in the execution time information acquiring process S300.

Note that although only the case where the “user” operates the client 100 to communicate with the server 120 is shown in the flows in FIGS. 3A and 3B, similar flows are followed also in the case where another user simultaneously operates a client (e.g. client 101) other than the client 100 to communicate with the server 120.

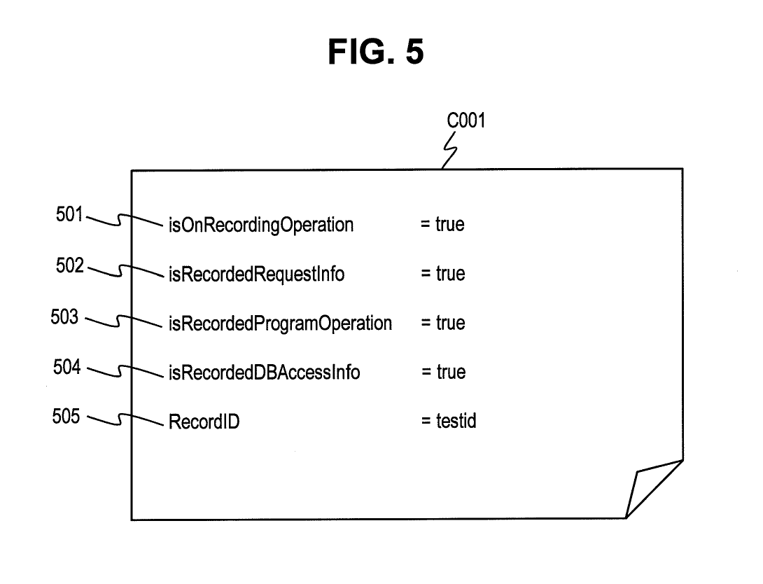

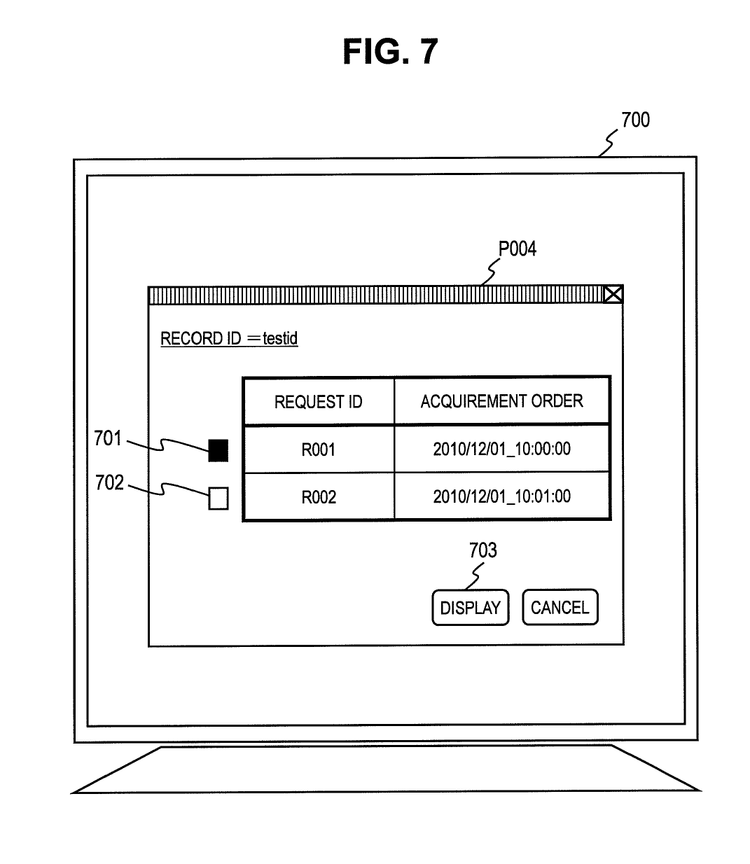

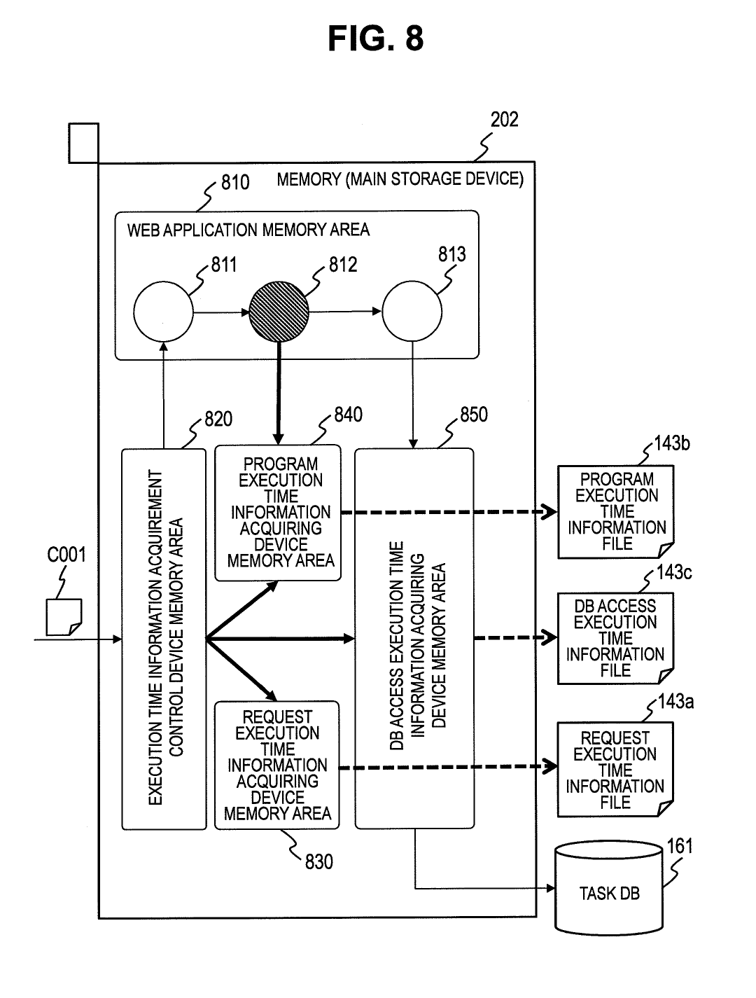

FIG. 4 shows a screen example 400 showing an execution time information acquirement information setting page P001 and a task page P002 in the execution time information acquiring process S300 of storing the execution time information of the task application 131. Further, FIGS. 6 and 7 show screen examples 600, 700 showing execution time information reference pages P003, P004 displayed by the client 100 and showing the execution time information recorded in the execution time information acquiring process S300 in the execution time reference process S310 of referring to the execution time information of the task application 131. Using these figures, a process executed by the client 100 is described in detail below.

In FIG. 3A, the client 100 displays the task page P002 (FIG. 4) of the task application on the display using a browser in accordance with an input operation for a task process from the “user” (S301). Here, since no instruction to acquire the execution time information is given from the “user”, the value of a key “isOnRecordingOperation” indicating whether or not it is necessary to acquire information included in the execution time information acquirement information C001 is “false”. The execution time information acquirement information C001 is described later. Thus, the server 120 does not execute the process of acquiring the execution time information of the task application 131.

Subsequently, the client 100 instructs the server to display the execution time information acquirement information setting page P001 (FIG. 4) on the display in accordance with an input operation for the execution time information recording process from the “user” and this page is displayed on the display of the client 100 (S302).

Subsequently, the client 100 instructs the server to start acquiring the execution time information in accordance with an input operation by the “user” performed via the execution time information acquirement information setting page P001 (S303). Specifically, a “record ID” is entered in an input form 401 by the “user”, and the type of the execution time information desired to be acquired is selected by graphical user interfaces (GUIs) 402, 403 and 404 such as check boxes. Thereafter, a GUI 405 such as a “Start” button is pressed down by the “user”, thereby instructing the server 120 to start acquiring the execution time information.

The value of the “record ID” in the input form 401 is an ID indicating the execution time information to be recorded thereafter, and used in specifying the execution time information in various managements (e.g. execution time information reference process S310 to be described later) thereafter.

Here, when the “Start” button 405 is pressed down by the “user”, the client 100 instructs to start acquiring the execution time information by setting the value of a key “isRecordingOperation” of execution time information acquirement information 501 to “true”. Simultaneously, the client 100 indicates the types of the execution time information desired to be acquired to the server 120 by respectively setting the value of a key “isRecordedRequestInfo” of request execution time information acquirement information 502, that of a key “isRecordedProgramOperation” of program execution time information acquirement information 503 and that of a key “isRecordedDBAccessInfo” of DB access execution time information acquirement information (504) to “true” in correspondence with the contents of the GUIs 402, 403 and 404 checked by the “user” on the execution time information acquirement information setting page P001.

Further, if the “user” removes a check from the check box, the client 100 can set the value of the corresponding key on the execution time information acquirement information setting page P001 to “false”, thereby being able to instruct the server to remove the set execution time information from the acquirement target.

Subsequently, the client 100 instructs a specified task process to the server 120 in accordance with an input operation from the user via the task page P002 (S304). Specifically, the value of a “product ID” is entered in an input form 411 of the task page P002 (FIG. 4) by the “user” and, then, the client 100 instructs a product searching process such as when a “Search” button 412 is pressed. At this time, the client 100 also transmits the execution time information acquirement information C001 in transmitting a request for a product search or the like to the server 120. The server 120 reads whether or not to acquire the execution time information, the type of the execution time information to be acquired and the like from the transmitted execution time information acquirement information C001.

Subsequently, the client 100 instructs the server 120 to stop acquiring the execution time information in accordance with an input operation from the “user” via the execution time information acquirement information setting page P001 (S304). Specifically, when a “Finish” button 406 is pressed by the “user” via the execution time information acquirement information setting page P001 (FIG. 4), the client 100 sets the value of the key “isOnRecordingOperation” of the execution time information acquirement information 501 to “false”. From the next time on, the execution time information acquirement information C001, the value of the key “isOnRecordingOperation” of which is set at “false”, is added to a request (task process request) transmitted from the client 100 to the server 120, and the server 120 does not acquire the execution time information.

In this way, the “user” performs a series of operations from the operation of starting acquirement of the execution time information (302) to the operation of ending acquirement of the execution time information (304), whereby the execution time information can be acquired only for the process of the task operated by the “user” himself.

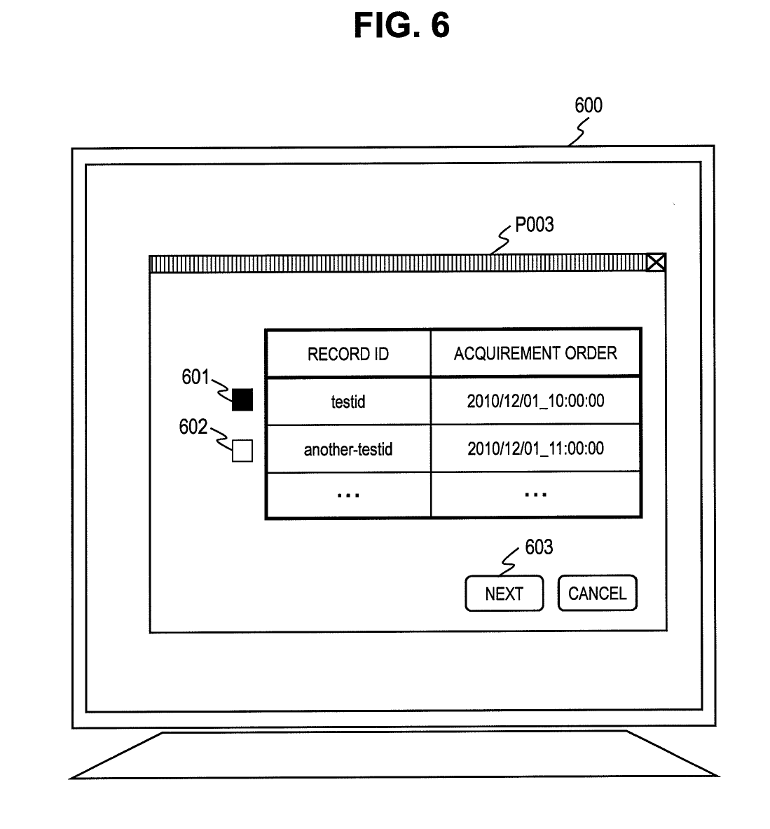

FIG. 5 shows an example of the execution time information acquirement information C001 used by the client 100 in the above execution time information acquiring process S300. The execution time information acquirement information C001 is set by the client 100 based on the instructions from the user input to the execution time information acquirement information setting page P001 in S303 and S305 of the execution time information acquiring process S300, and the server 120 performs various processes according to the set contents.

The execution time information acquirement information C001 includes the execution time information acquirement information 501, the request execution time information acquirement information 502, the program execution time information acquirement information 503, the DB access execution time information acquirement information 504 and a record ID 505.

The execution time information acquirement information 501 is expressed in a key-value format and indicates the start of acquiring the execution time information when the value for the key “isOnRecordingOperation” is “true”. On the other hand, it indicates the end of acquiring the execution time information if the value is “false”.

The request execution time information acquirement information 502 is expressed in a key-value format, and the request execution time information acquiring device 143 acquires the execution time information in a request if the value for the key “isRecordedRequestInfo” is “true”. On the other hand, if the value is “false”, it indicates the end of acquiring the execution time information in the request and the request execution time information acquiring device 143 stops acquiring the execution time information in the request.

The program execution time information acquirement information 503 is expressed in a key-value format and the program execution time information acquiring device 144 acquires the execution time information of a program if the value for a key “isRecordedProgramOperation” is “true”. On the other hand, if the value is “false”, it indicates the end of acquiring the execution time information of the program and the program execution time information acquiring device 144 stops acquiring the execution time information of the program.

The DB access execution time information acquirement information 504 is expressed in a key-value format and the DB access execution time information acquiring device 145 acquires the execution time information of a DB access if the value for the key “isRecordedDBAccessInfo” is “true”. On the other hand, if the value is “false”, it indicates the end of acquiring the execution time information of the DB access and the DB access execution time information acquiring device 145 stops acquiring the execution time information of the DB access.

The record ID 505 is an item uniquely specifying the recorded execution time information and expressed in a key-value format. In this embodiment, a character string or the like entered by the user himself on the execution time information acquirement information setting page P001 is set as a value for a key “RecordID”.

Writing into a cookie and the like can be cited as a specific means for giving certain information to a request from a page displayed on a browser such as the execution time information acquirement information setting page P001 in this way. That is, when the user instructs to start/stop acquiring the execution time information using the execution time information acquirement information setting page P001, the client PC stores the execution time information acquirement information C001 generated based on the instruction in a memory. At this time, every time the user issues a request using the task page P002, the client 100 having received this adds the execution time information acquirement information C001 stored in the memory to the request and transmits the resultant to the server 120.

Next, the execution time information reference process S311, which is a process of referring to the execution time information acquired by the above execution time information acquiring process S300, is described using FIG. 3B.

The client 100 displays the execution time information reference page P003 used to refer to the recorded execution time information on the display in accordance with an input operation from the “user” (S311). The execution time information reference page P003 is so displayed as to relate the “record IDs” and “acquirement orders” in time at which acquirement of the execution time information was started. GUIs 601, 602 such as check boxes are displayed for the “record IDs” and the “acquirement orders” in a correspondence relationship.

Subsequently, the client 100 displays the execution time information P004 (FIG. 7), which displays the execution time information on various requests included in the selected “record ID”, on the display in accordance with a selection operation made to the GUI 601 or the like and pressing of a “Next” button (S312) from the user. The execution time information reference page P004 shown in FIG. 7 is so displayed as to relate “request IDs” identifying various requests included in a series of task process requests and times at which the execution time information on the execution of such requests was obtained.

Note that although an example of displaying a list of requests included in the “testid” of “record ID” is shown in FIG. 7, execution time information reference screens P004 may be displayed for respective record IDs while being arranged on the same screen or may be displayed in one form format if a plurality of “record IDs” are selected on the execution time information reference screen P003 (FIG. 4).

Subsequently, the client 100 graphically displays the execution time information per selected request in accordance with a selection operation of GUIs 701, 702 which are check boxes corresponding to the “request IDs” and pressing of a “Display” button 703 (S313).

By performing the execution time information reference process 310 in this way, the user can refer to the execution time information of only the process of the task designated by himself.

Processes of the server 120 in response to the processes in the client 100 shown in FIGS. 3A and 3B are described below.

First, a process at the server machine 120 in response to the execution time information acquiring process S300 (FIG. 3A) is described.

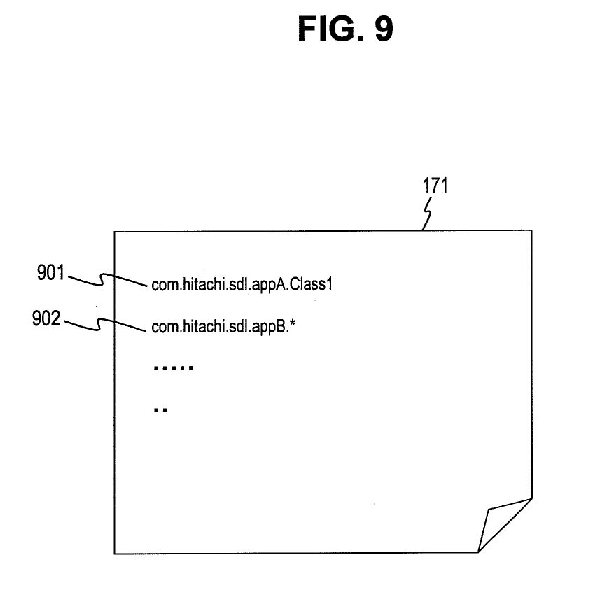

FIG. 8 shows the configuration of the memory (main storage device 202) in the server 120 for a thread matched with one received request in processing the request transmitted from the client 100 to the server 120 in the execution time information acquiring process S300. In this embodiment, the memory 202 is assumed to be composed of a web application memory area 810, an execution time information acquirement control device memory area 820, a request execution time information acquiring device memory area 830, a program execution time information acquiring device memory area 840, a DB access execution time information acquiring device memory area 850 and the like.

The web application memory area 810 is a memory area used by the web applications 130. In this embodiment, the web applications written in Java language are supposed, and objects 811, 812 and 813 instantiated from the class file are assumed to be allocated. Particularly, the object 812 is an instance of the class file listed in the execution time information acquirement target list 171 and a machine code used to acquire the execution time information is inserted by the program execution platform 150.

The execution time information acquirement control device memory area 820 is a memory area used by the execution time information acquirement control device 141.

The request execution time information acquiring device memory area 830 is a memory area used by the request execution time information acquiring device 142a.

The program execution time information acquiring device memory area 840 is a memory area used by the program execution time information acquiring device 142b.

The DB access execution time information acquiring device memory area 850 is a memory area used by the DB access execution time information acquiring device 142c.

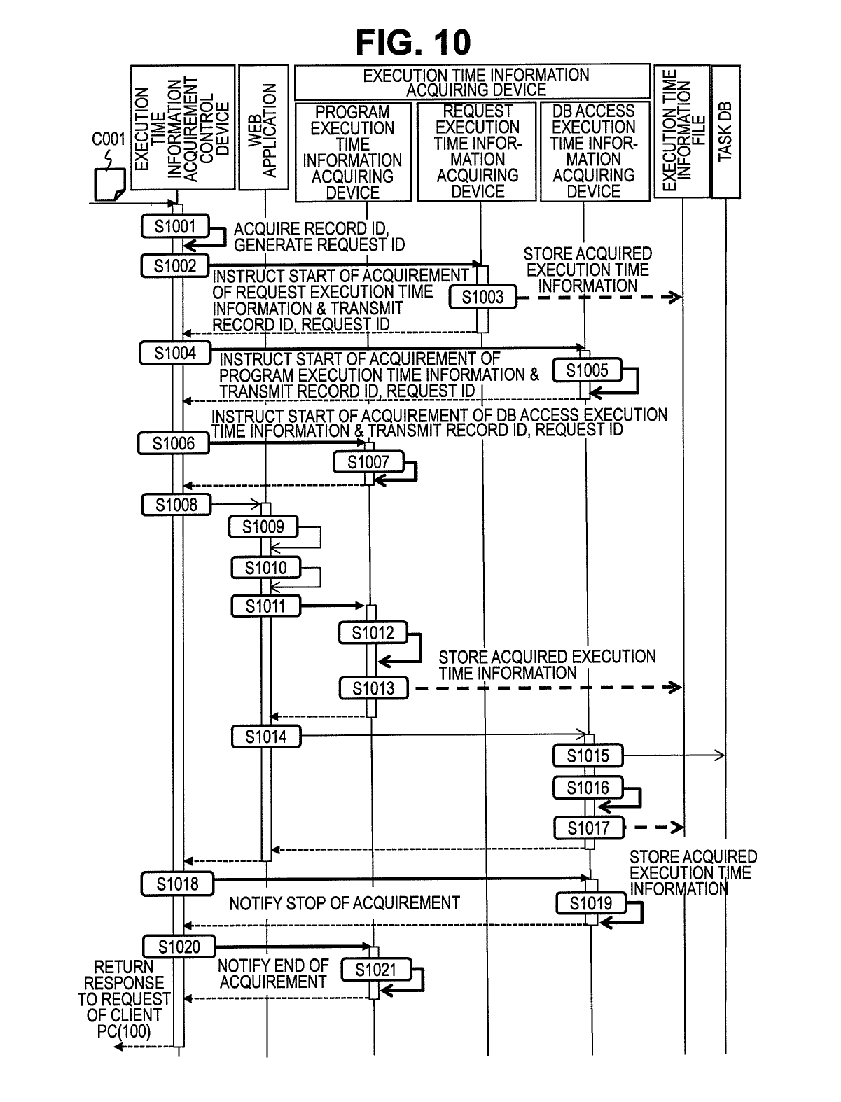

FIG. 9 shows an example of the execution time information acquirement target list 171 referred when the program execution platform 150) inserts the machine code used to acquire the program execution time information. The execution time information acquirement target list 171 is a file storing the file name and the like of the program for acquiring the execution time information and designated by class name 901 of the program written in Java language in this embodiment. Further, by using symbols such as “*” as wild cards, it is also possible to designate all the classes under the package (902).

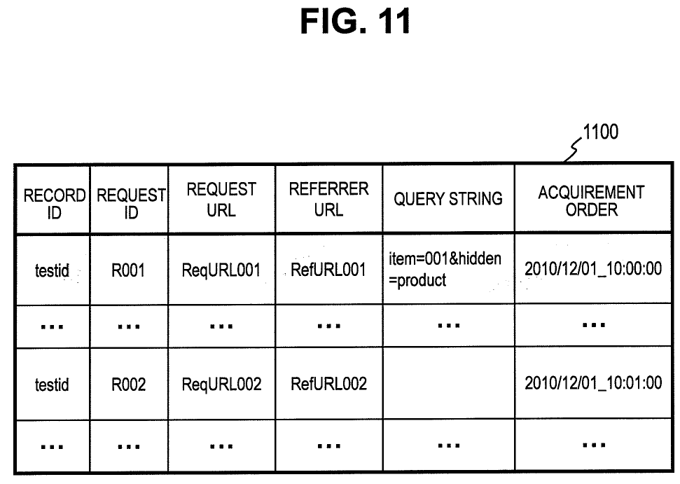

FIG. 10 shows the flow of a process in the server 120 when the server 120 receives a task process request added with the execution time information acquirement information C001 (FIG. 5). Note that FIG. 10 shows in correspondence with the configuration of the memory in the server 120 shown in FIG. 8. Through this process flow, the server 120 stores the execution time information corresponding to the process on the memory (main storage device 202) shown in FIG. 8 in the execution time information file 143 in accordance with the content of the execution time information acquirement information C001 added to the request.

This flow is started when the server 120 receives a request transmitted from the client 100.

The execution time information acquirement control device 141 acquires the value of the “record ID” from the execution time information acquirement information C001 added to the request and generates a “request ID” uniquely specifying the request transmitted from the client 100 (S1001).

Subsequently, the execution time information acquirement control device 141 transmits the values of the “record ID” and the “request ID” to the request execution time information acquiring device 142a together with an instruction message to start acquiring the request execution time information in accordance with the execution time information acquirement information C001 added to the request (S1002). In this embodiment, if the example of the execution time information acquirement information C001 of FIG. 5 is used, a message to start acquiring the execution time information is transmitted when the value for the key “isOnRecordingOperation” of the execution time information acquirement information 501 is “true” and the value for the key “isRecordedRequestInfo” of the request execution time information acquirement information 502 is “true”. On the other hand, the message to start acquiring the execution time information is not transmitted when the value for the key “isOnRecordingOperation” of the execution time information acquirement information 501 is “false” or the value for the key “isRecordedRequestInfo” of the request execution time information acquirement information 502 is “false”.

Subsequently, the request execution time information acquiring device 142a acquires the request execution time information and stores it together with the values of the “record ID” and the “request ID” in the request execution time information file 143a (S1003) when receiving a message to start acquiring the request execution time information from the execution time information acquirement control device 141.

Subsequently, the execution time information acquirement control device 141 transmits the values of the “record ID” and the “request ID” to the program execution time information acquiring device 142b together with an instruction message to start acquiring the execution time information in accordance with the content of the execution time information acquirement information C001 added to the request and received from the client 100 (S1004). In this embodiment, if the example of the execution time information acquirement information C001 of FIG. 5 is used, a message to start acquiring the program execution time information is transmitted when the value for the key “isOnRecordingOperation” of the execution time information acquirement information 501 is “true” and the value for the key “isRecordedProgramOperation” of the program execution time information acquirement information 503 is “true”. On the other hand, the message to start acquiring the program execution time information is not transmitted when the value for the key “isOnRecordingOperation” of the execution time information acquirement information 501 is “false” or the value for the key “isRecordedProgramOperation” of the program execution time information acquirement information 503 is “false”.

Subsequently, the program execution time information acquiring device 142b sets a program execution time information acquirement start flag and stores the values of the “record ID” and the “request ID” in the program execution time information acquiring device memory area 840 (S1005) when receiving the message to start acquiring the program execution time information from the execution time information acquirement control device 141.

Subsequently, the execution time information acquirement control device 141 transmits the values of the “record ID” and the “request ID” to the DB access execution time information acquiring device 142c together with an instruction message to start acquiring the DB access execution time information in accordance with the content of the execution time information acquirement information C001 added to the request (S1006). In this embodiment, if the example of the execution time information acquirement information C001 of FIG. 5 is used, a message to start acquiring the DB access execution time information is transmitted when the value for the key “isOnRecordingOperation” of the execution time information acquirement information 501 is “true” and the value for the key “isRecordedDBAccessInfo” of the DB access execution time information acquirement information 504 is “true”. On the other hand, the message to start acquiring the DB access execution time information is not transmitted when the value for the key “isOnRecordingOperation” of the execution time information acquirement information 501 is “false” or the value for the key “isRecordedDBAccessInfo” of the DB access execution time information acquirement information 504 is “false”.

Subsequently, the DB access execution time information acquiring device 142c sets a DB access execution time information acquirement start flag and stores the values of the “record ID” and the “request ID” in the DB access execution time information acquiring device memory area 850 (S1007) when receiving the message to start acquiring the DB access execution time information from the execution time information acquirement control device 141.

Subsequently, the execution time information acquirement control device 141 calls the web application corresponding to the request received by the server 1008. In this embodiment, the object 811 in the web application memory area 810 is called.

Subsequently, the object 811 in the web application memory area 810 calls the object 812 (S1009).

Subsequently, the object 812 in the web application memory area 810 calls the object 813 (S1010).

Subsequently, the object 812 in the web application memory area 810 transmits the program execution time information to the program execution time information acquiring device 142b in accordance with the machine code embedded by the program execution device 150 (S1011).

Subsequently, the program execution time information acquiring device 142b refers to the execution time information acquirement start flag set in the program execution time information acquiring device memory area 840 when receiving the program execution time information from the object 812 in the web application memory area 810 (S1012).

Subsequently, the program execution time information acquiring device 142b acquires the received program execution time information and stores it together with the recorded “record ID” and “request ID” in the program execution time information file 143b (S1013) if the referred execution time information acquirement start flag is set.

Subsequently, the object 813 in the web application memory area 810 transmits a message requesting an operation such as reference to task data stored in the task DB 161 to the DB access execution time information acquiring device 142c (S1014).

Subsequently, the DB access execution time information acquiring device 142c establishes connection to the task DB 161 and performs the operation of the task data requested from the object 813 in the web application memory area 810 (S1015).

Subsequently, the DB access execution time information acquiring device 142c refers to the DB access execution time information acquirement start flag set in the DB access execution time information acquiring device memory area 850 (S1016).

Subsequently, the DB access execution time information acquiring device 142c acquires the DB access execution time information in S1015 and stores it together with the “record ID” and the “request ID” stored therein in the DB access execution time information file 143c (S1017) if the referred DB access execution time information acquirement start flag is set.

Subsequently, the execution time information acquirement control device 141 transmits a message to stop acquiring the DB access execution time information to the DB access execution time information acquiring device 142c (S1018).

Subsequently, the DB access execution time information acquiring device 142c clears the DB access execution time information acquirement start flag set in the DB access execution time information acquiring device memory area 850 (S1019) when receiving the message to stop acquiring the DB access execution time information.

Subsequently, the execution time information acquirement control device 141 transmits a message to stop acquiring the program execution time information to the program execution time information acquiring device 142b (S1020).

Subsequently, the program execution time information acquiring device 142b clears the program execution time information acquirement start flag set in the program execution time information acquiring device memory area 840 (S1021) when receiving the message to stop acquiring the program execution time information.

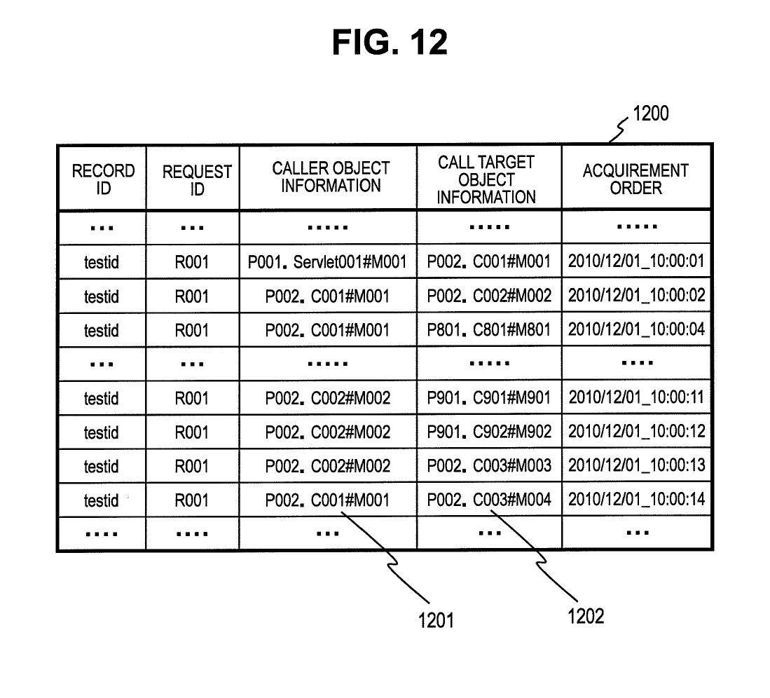

FIG. 11 shows an example 1100 of the execution time information stored in the request execution time information file 143a through the process (S1002) in the request execution time information acquiring device 142a. In this example, “record ID”, “request ID”, “request URL”, “referrer URL”, “query string” and “acquirement order” are listed.

The “record ID” is an item specifying execution time information acquired for each user and, in this embodiment, the value of the “record ID” can be acquired when the request execution time information acquiring device 142a receives a message to start acquiring the execution time information from the execution time information acquirement control device 141.

The “request ID” is an item uniquely specifying a request and mechanically given in the execution time information acquirement control device 141. The value of the “request ID” can be acquired when the request execution time information acquiring device 142a receives the message to start acquiring the execution time information from the execution time information acquirement control device 141.

The “request URL” is an item specifying a resource in the web application requested by the request. For example, in the case of Java language, it can be mechanically acquired from a javax.servlet.http.HttpServletRequest object generated upon receiving the request.

The “referrer URL” is an item specifying a resource (of the web application displayed on the client PC) having transmitted the request. For example, in the case of Java language, it can be mechanically acquired from the javax.servlet.http.HttpServletRequest object generated upon receiving the request.

The “query string” is an item indicating user input data added to the request. For example, on a page written in HTML, the value entered in a form displayed by a form tag can be transmitted to the server by being added to the request. Further, in the case of Java language, it can be mechanically acquired from the javax.servlet.http.HttpServletRequest object generated upon receiving the request.

The “acquirement order” is an item indicating an order of storing the request execution time information acquired by the request execution time information acquiring device 142a in the request execution time information file 143a and can be mechanically acquired in the request execution time information acquiring device 142a. In this example, times displayed in a YYYY/MM/DD_HH:mm:SS format are listed.

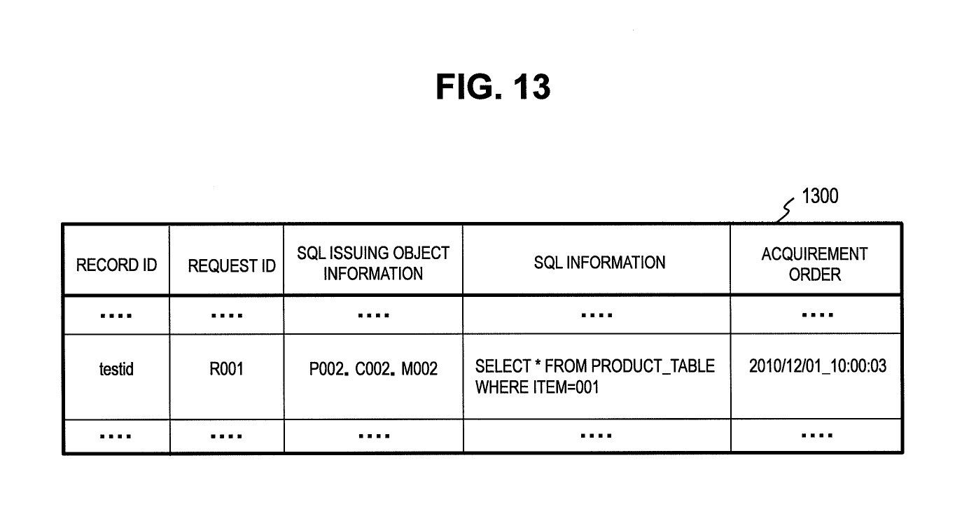

FIG. 12 shows an example 1200 of the execution time information acquired by the program execution time information acquiring device 142b. In this embodiment, “record ID”, “request ID”, “caller object information”, “call target object information” and “acquirement order” are listed.

The “record ID” is an item specifying execution time information acquired for each user. In this example, the value of the “record ID” can be acquired when the program execution time information acquiring device 142b receives a message to start acquiring the execution time information from the execution time information acquirement control device 141.

The “request ID” is an item uniquely specifying a request and mechanically given in the execution time information acquirement control device 141. The value of the “request ID” can be acquired when the program execution time information acquiring device 142b receives the message to start acquiring the execution time information from the execution time information acquirement control device 141.

The “caller object information” is an item indicating information possessed by the object that transmits a message to another object and can be acquired by the machine code inserted by the program execution device 150 and used to acquire the execution time information. In this embodiment, if 1201 of the example 1200 of the program execution time information is used, a character string “P002” corresponding to a Java language package and a character string “C001” corresponding to the class of the object are connected by a symbol such as “.” and the character string “C001” corresponding to the class and a character string “M001” corresponding to a method are connected by a symbol such as “#”.

The “call target object information” is an item indicating information on the object as a message transmission destination of a certain object and can be acquired by the machine code inserted by the program execution device 150 and used to acquire the execution time information when the object as a caller transmits a message. In this embodiment, similar to the above “caller object information”, the character string corresponding to the Java language package and the character string corresponding to the class of the object are connected by a symbol such as “.” and the character string corresponding to the class and the character string corresponding to the method are connected by a symbol such as “#”.

The “acquirement order” is an item indicating an order of acquiring call relationship information among the objects and can be acquired by the machine code inserted by the program execution platform 150. In this example, times displayed in a YYYY/MM/DD_HH:mm:SS format are listed.

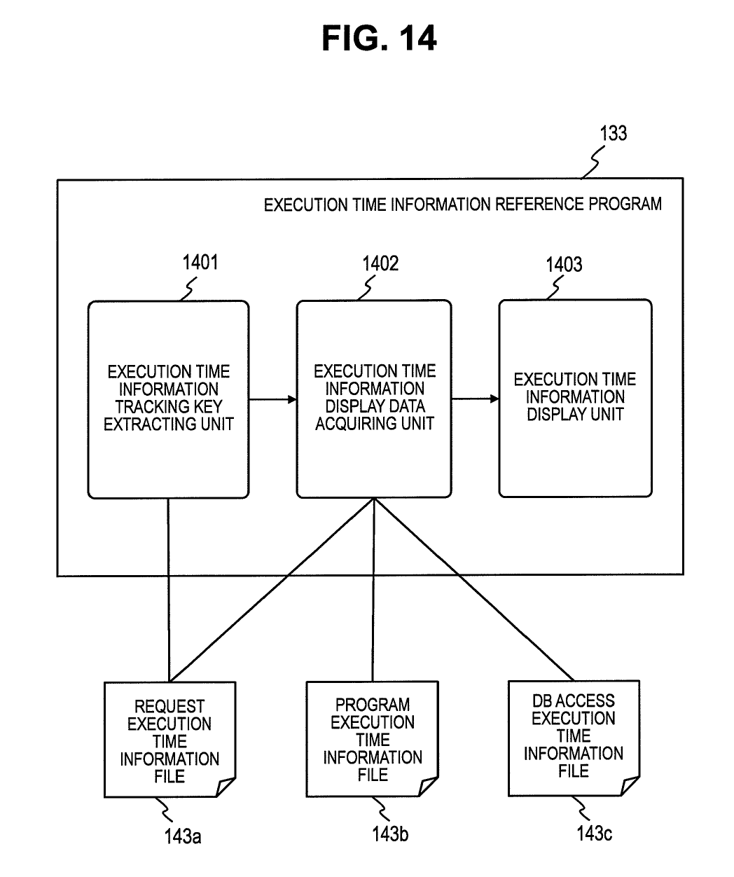

FIG. 13 shows an example 1300 of the execution time information acquired in the DB access execution time information acquiring device 142c. In this example, “record ID”, “request ID”, “SQL issuing object information”, “SQL information” and “acquirement order” are listed.

The “record ID” is an item specifying execution time information acquired for each user and, in this example, the value of the “record ID” can be acquired when the DB access execution time information acquiring device 142c receives a message to start acquiring the execution time information from the execution time information acquirement control device 141.

The “request ID” is an item uniquely specifying a request and mechanically given in the execution time information acquirement control device 141. The value of the “request ID” can be acquired when the DB access execution time information acquiring device 142c receives the message to start acquiring the execution time information from the execution time information acquirement control device 141.

The “SQL issuing object information” is an item indicating information on the object that receives a message to operate the task data from the web application 130 and executes a process of operating the data of the DB written in SQL or the like, and can be mechanically acquired in the DB access execution time information acquiring device 142c. In this embodiment, similar to the above “caller object information”, the character string corresponding to the Java language package and the character string corresponding to the class of the object are connected by a symbol such as “.” and the character string corresponding to the class and the character string corresponding to the method are connected by a symbol such as “#”.

The “SQL information” is an item indicating the content of the process such as a data operation of the task DB 161. In this embodiment, character strings such as the one “SELECT *FROM PRODUCT_TABLE WHERE ITEM=001” written in SQL language are listed.

The “acquirement order” is an item indicating an order of acquiring DB access execution time information in the DB access execution time information acquiring device 142c and can be mechanically acquired in the DB access execution time information acquiring device 142c. In this embodiment, times displayed in a YYYY/MM/DD_HH:mm:SS format are listed.

The above is the description of the process of the server 120 in the execution time information acquiring process S300 of the client 100.

Next, the operation of the server 120 in the execution time information reference process S310 of referring to the recorded execution time information is described.

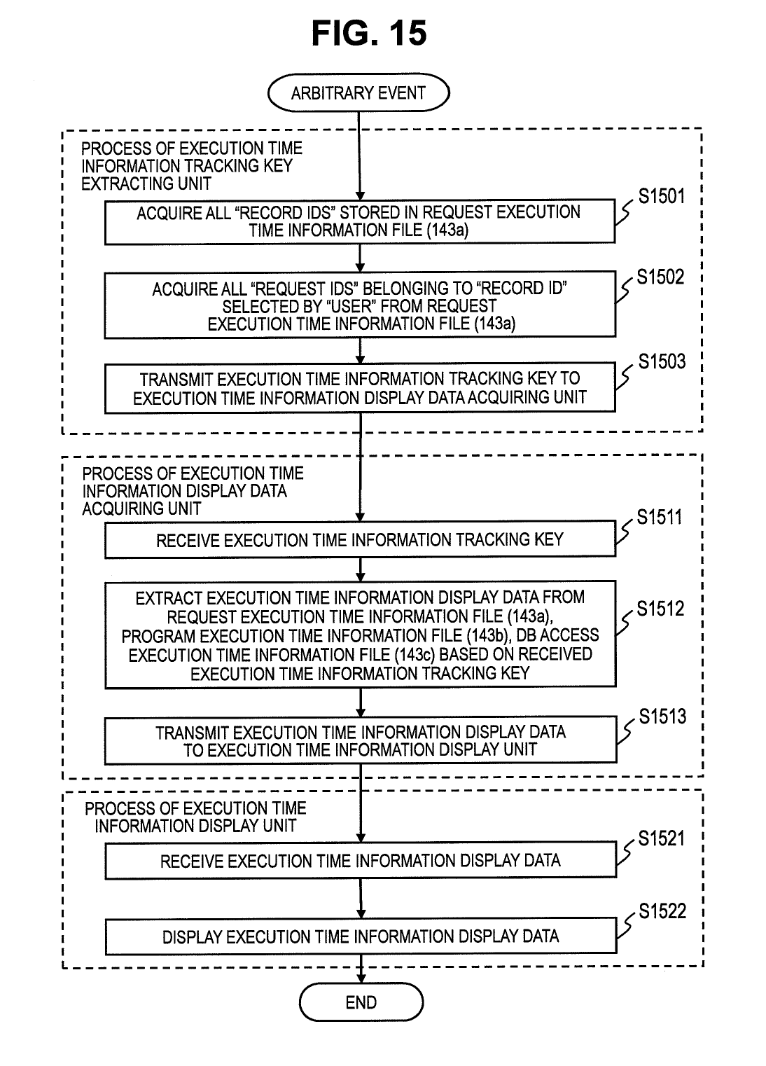

FIG. 14 is a diagram showing the module configuration of the execution time information reference program 133 that causes the server 120 to execute this process. The execution time information reference program 133 includes an execution time information tracking key extracting module 1401, an execution time information display data acquiring module 1402 and an execution time information display module 1403.

The execution time information tracking key extracting module 1401 has a function of extracting an “execution time information tracking key” used to extract the execution time information acquired by the server 120. In this embodiment, a set of the “record ID” that can be obtained from the request execution time information file 143a and the “request ID” belonging thereto is used as the “execution time information tracking key”.

The execution time information display data acquiring module 1402 has a function of extracting execution time information display data based on the “execution time information tracking key” acquired in the execution time information tracking key extracting module 1401. In this embodiment, the execution time information display data is assumed to be extracted from the request execution time information file 143a, the program execution time information file 143b and the DB access execution time information file 143c based on the “execution time information tracking key”.

The execution time information display module 1403 has a function of graphically displaying the execution time information display data extracted in the execution time information display data acquiring module 1402.

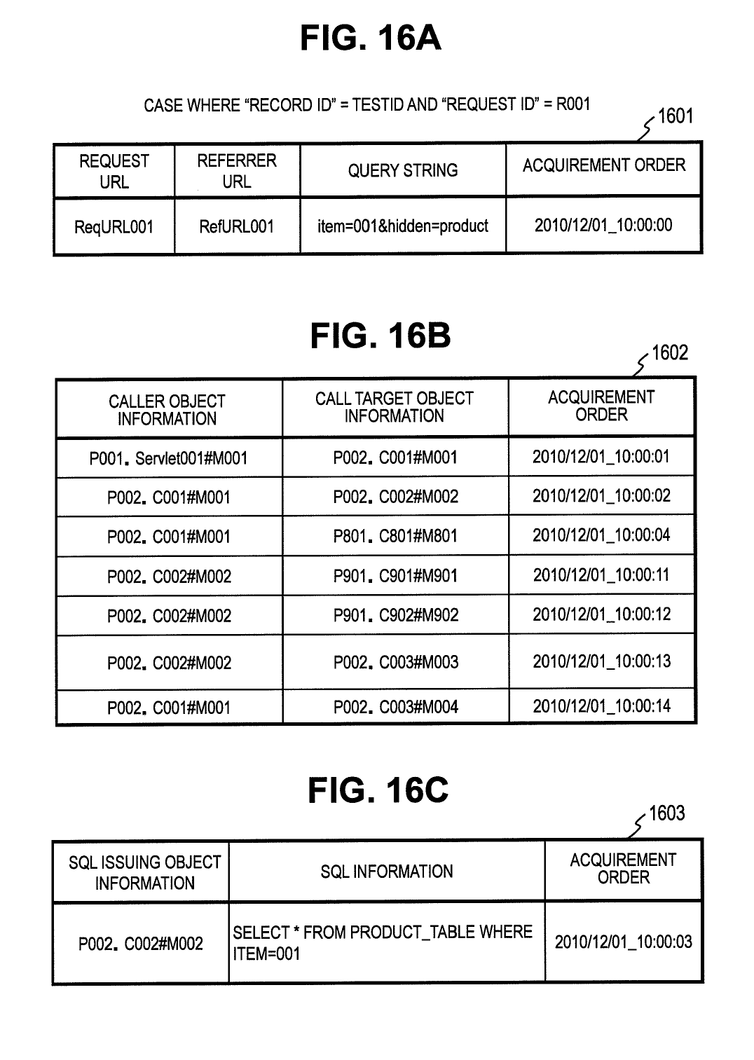

FIG. 15 shows a process flow of modules constituting the execution time information reference application 133. The process flow shown in FIG. 15 is started when the client 100 transmits a request to refer to execution time information to the server 120 in accordance with an input operation from the “user” via the execution time information reference page P003 displayed on the client 100.

The execution time information tracking key extracting module 1401 acquires all the “record IDs” stored in the request execution time information file 143a (S1501). In this embodiment, it is assumed that the “record IDs” acquired in Step S1501 can be displayed on the execution time information reference page P003 and the “user” can select one from a list of the displayed “record IDs”.

Subsequently, the execution time information tracking key extracting module 1401 acquires all “request IDs” belonging to the “record ID” selected by the “user” from the request execution time information file 143a (S1502). In this embodiment, it is assumed that the “request IDs” acquired in Step S1502 can be displayed on the execution time information reference page P004 and the “user” can select one from a list of the displayed “request IDs”.

Subsequently, the execution time information tracking key extracting module 1401 transmits the execution time information tracking key selected by the “user” to the execution time information display data acquiring module 1402 (S1503).

Subsequently, the execution time information display data acquiring module 1402 receives the execution time information tracking key (S1511) and extracts respective records including the received execution time information tracking key from the request execution time information file 143a, the program execution time information file 143b and the DB access execution time information file 143c (S1512).

Subsequently, the execution time information display data acquiring module 1402 transmits the extracted execution time information display data to the execution time information display module 1403 (S1513).

Subsequently, the execution time information display module 1403 receives the execution time information display data (S1521) and graphically displays the relationship of the execution time information (S1522).

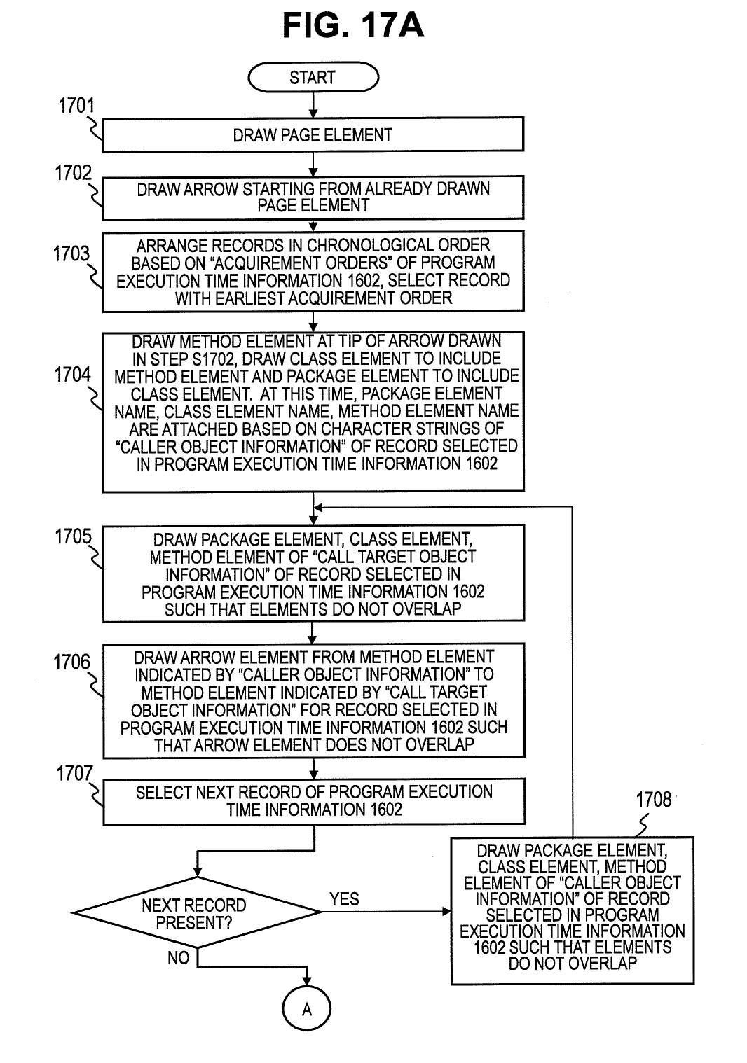

Various pieces of execution time information extracted in Step S1512 of the process flow of the modules constituting the execution time information reference program 133 shown in FIG. 15 are illustrated in FIGS. 16A to 16C. Note that a case where the “record ID” is “testid” and the “request ID” is “R001” is illustrated in FIGS. 16A to 16C.

FIG. 16A shows an example 1601 of the request execution time information extracted in Step S1512. In this embodiment, “request URL”, “referrer URL”, “query string” and “acquirement order” are listed.

The “request URL” corresponds to the “request URL” of the request execution time information 1100. The “referrer URL” corresponds to the “referrer URL” of the request execution time information 1100. The “query string” corresponds to the “query string” of the request execution time information 1100. The “acquirement order” corresponds to the “acquirement order” of the request execution time information 1100.

FIG. 16B shows an example 1602 of the program execution time information extracted in Step S1512. In this embodiment, “caller object information”, “call target object information” and “acquirement order” are listed.

The “caller object information” corresponds to the “caller object information” of the program execution time information 1200. The “call target object information” corresponds to the “call target object information” of the program execution time information 1200. The “acquirement order” corresponds to the “acquirement order” of the program execution time information 1200.

FIG. 16C shows an example 1603 of the program execution time information extracted in Step S1512. In this embodiment, “SQL issuing object information”, “SQL information” and “acquirement order” are listed.

The “SQL issuing object information” corresponds to the “SQL issuing object information” of the DB access execution time information 1300. The “SQL information” corresponds to the “SQL information” of the DB access execution time information 1300. The “acquirement order” corresponds to the “acquirement order” of the DB access execution time information 1300.

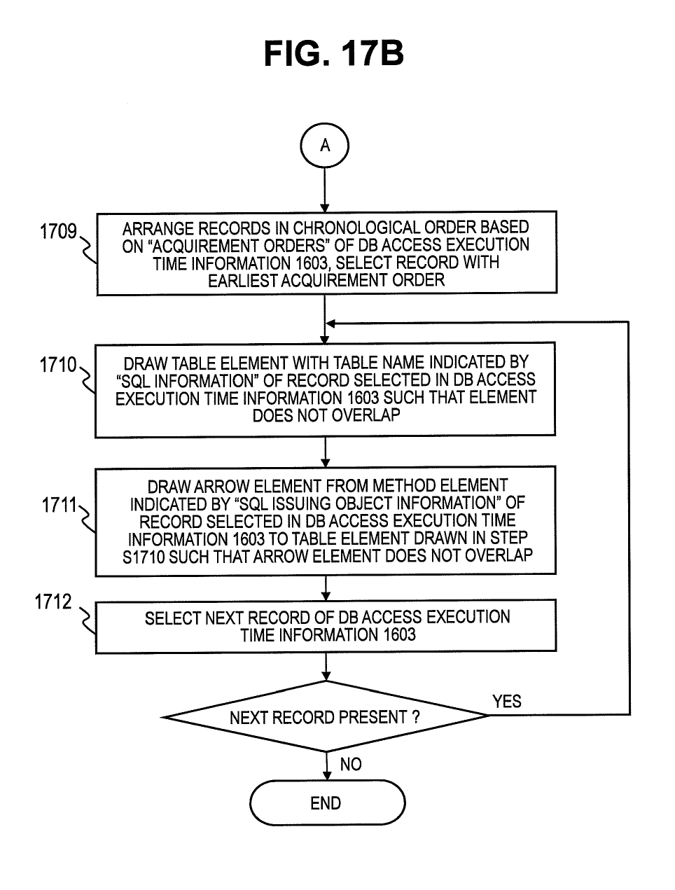

FIGS. 17A and 17B show a process flow of displaying the execution time information display data in Step S1522 in the process flow of the execution time information display module 1403.

This process flow is started such as when the execution time information display data is received from the execution time information display data acquiring module 1402.

The execution time information display module 1403 draws a page element and attaches the “acquirement order” of the request execution time information 1601 above the page element and the “referrer URL” of the request execution time information 1601 below the page element (S1701).

Subsequently, the execution time information display module 1403 draws an arrow starting from the page element drawn in S1701 and attaches the “request URL” of the request execution time information 1601 above the arrow and the “query string” of the request execution time information 1601 below the arrow.

Subsequently, the execution time information display module 1403 rearranges the records in a chronological order based on the “acquirement orders” of the program execution time information 1602 and selects the record with the earliest “acquirement order” (S1703).

Subsequently, the execution time information display module 1403 draws a method element at the tip of the arrow drawn in S1702 and draws a class element to include the method element and a package element to include the class element (S1704). The display names of the package element, the class element and the method element drawn in this Step are given based on character strings of the “caller object information” of the record selected in the program execution time information 1602.

Subsequently, the package element, the class element and the method element of the “call target object information” of the record selected in the program execution time information 1602 are so drawn as not to overlap (S1705).

Subsequently, the execution time information display module 1403 draws an arrow element connecting between the method element indicated by the “caller object information” of the record selected in the program execution time information 1602 and that indicated by the “call target object information” of the record selected in the program execution time information 1602 such that the arrow element does not overlap (S1706). At this time, the “acquirement order” of the record selected in the program execution time information 1602 is attached as a label to the arrow element.

Subsequently, the execution time information display module 1403 selects the next record of the program execution time information 1602 (S1707).

Subsequently, when judging that the record of the program execution time information 1602 selected in Step S1707 is present, the execution time information display module 1403 draws a package element, a class element and a method element of the “caller object information” of this record such that these elements do not overlap (S1708) and returns to Step S1705. On the other hand, when judging that the record of the program execution time information 1602 selected in Step S1707 is absent, the execution time information display module 1403 proceeds to next Step S1709 since it indicates that the drawing of the program execution time information 1602 has been finished.

Subsequently, the execution time information display module 1403 rearranges the records in a chronological order based on the “acquirement orders” of the DB access execution time information 1603 and selects the record with the earliest “acquirement order” (S1709).

Subsequently, the execution time information display module 1403 analyzes the “SQL information” of the record selected in the DB access execution time information 1603 to obtain a table name and draws the table name (S1710) only when there is no other table element having the same table name.

Subsequently, the execution time information display module 1403 draws an arrow element connecting between a method element indicated by the “SQL issuing object information” of the record selected in the DB access execution time information 1603 and the table element drawn in S1710 such that the arrow element does not overlap (S1711). At this time, the execution time information display module 1403 attaches the “SQL information” and the “acquirement order” of the selected record as labels to the arrow element

Subsequently, the execution time information display module 1403 selects the next record of the DB access execution time information 1603 (S1712). A return is made to Step S1710 if the selected record is judged to be present. On the other hand, when judging that the selected record is absent, the execution time information display module 1403 finishes the display of the execution time information display data since it indicates that the drawing of the DB access execution time information 1603 has been finished.

The process flow shown in FIGS. 17A and 17B is a process flow when the request execution time information 1601, the program execution time information 1602 and the DB access execution time information 1603 are all acquired. In this embodiment, whether or not to acquire each of various pieces of execution time information can be selected and the execution time information display module 1403 can display the execution time information display data according to the type of the execution time information selected to be acquired.

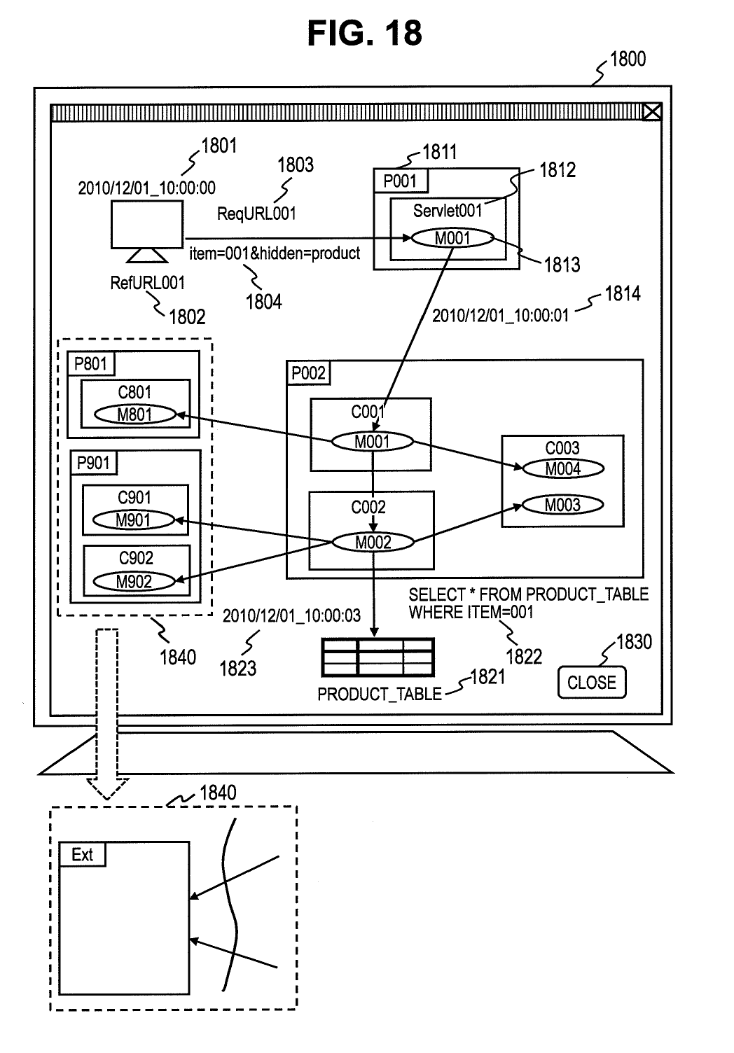

FIG. 18 shows a screen example 1800 displaying the execution time information in another window by the execution time information reference program 133 in Step S1522 of the execution time information display module 1403.

A label 1801 above a PC display-shaped element indicating a page corresponds to the “acquirement order” of the request execution time information 1601.

A label 1802 below the PC display-shaped element indicating the page corresponds to the “referrer URL” of the request execution time information 1601.

A label 1803 above an arrow extending from the PC display-shaped element indicating the page corresponds to the “request URL” of the request execution time information 1601.

A label 1804 below the arrow extending from the PC display-shaped element indicating the page corresponds to the “query string” of the request execution time information 1601.

A label 1811 of a rectangular element having a rectangle at the left upper corner corresponds to the character string indicating the package name out of the character strings of the “caller object information” or the “call target object information” of the program execution time information 1602.

A label 1812 of the rectangular element corresponds to the character string indicating the class name out of the character strings of the “caller object information” or the “call target object information” of the program execution time information 1602.

A label 1813 of an elliptical element corresponds to the character string indicating the method name out of the character strings of the “caller object information” or the “call target object information” of the program execution time information 1602.

A label 1814 of the arrow starting from the method element corresponds to the “acquirement order” of the program execution time information 1602. Although the “acquirement order” is not attached to all the arrows connecting the method elements to make the screen example easy to see in this embodiment, labels may be attached to all the arrows or some of them.

A label 1821 of a rectangular element partitioned by a lattice indicates the table name and can be obtained by analyzing the “SQL information” of the DB access execution time information 1603.

A right label 1822 of an arrow pointing to the rectangular element partitioned by the lattice corresponds to the character string of the “SQL information” of the DB access execution time information 1603.

A left label 1823 of the arrow pointing to the rectangular element partitioned by the lattice corresponds to the character string of the “acquirement order” of the DB access execution time information 1603.

There is also a method for displaying a part 1840 of the screen 1800 displaying the execution time information enclosed by a dotted line frame while omitting display contents as shown in a bottom part of FIG. 18.

The “user” can close the window displaying the execution time information by an operation such as pressing of a Close button 1830 and move onto an operation of referring to another execution time information or the like.

As described above, according to this embodiment, it is possible to acquire the execution time information of the web applications for each user and enable the user himself to determine the start and end of acquirement of the execution time information in maintenance and improvement of the information system. Thus, a work of sorting the acquired execution time information into related information and unrelated information (e.g. uninterested execution time information and execution time information by the other users) can be reduced, and lead time to investigate a cause in the event of a trouble and to understand the existing information system can be shortened. Further, it is possible to reduce performance deterioration of the web applications and a burden on the storage capacity caused by acquirement of the execution time information. Furthermore, it is not necessary to embed information for selectively acquiring the execution time information in a source code in advance. Note that the present invention is not limited to various examples described above and various changes can be made without departing from the scope of the gist thereof.

Further, various programs and data disclosed in this embodiment can be stored in various magnetic or optic storage media and can be obviously downloaded via various electric and electronic communication lines such as Internet.

What is claimed is:

1. A system for acquiring execution information of a process executed in a computer, comprising:
a client part for issuing an execution request for a process; and
a server part including an application execution part for executing a process according to an execution request from the client part and an execution information acquirement control part for controlling acquirement of execution information,
wherein the client part receives and stores a request to start acquiring execution information,
wherein the client part transmits a request to acquire execution information to the server part together with an execution request based on the stored request to start acquiring execution information upon receiving the execution request for the application execution part after receiving the request to start acquiring execution information,
wherein the application execution part executes a process based on the execution request, and
wherein the execution information acquirement control part stores execution information of the process executed by the application execution part in a storage device based on the request to acquire execution information.

2. The system according to claim 1,
wherein the client part receives and stores a request to stop acquiring execution information,
wherein the client part transmits information indicating no need to acquire execution information to the server part together with an execution request based on the request to stop acquiring execution information upon receiving each execution request for the application execution part after receiving the request to stop acquiring execution information,
wherein the application execution part executes a process based on the execution request, and
wherein the execution information acquirement control part performs control not to store execution information of the process executed by the application execution part in the storage device based on the information indicating no need to acquire execution information.

3. The system according to claim 1,
wherein the client part stores an ID identifying the request to start acquiring execution information upon receiving the request to start acquiring execution information, and
wherein the client part transmits a request to acquire execution information and the ID identifying the request to start acquiring to the server part together with an execution request upon receiving each execution request for the application execution part after receiving the request to start acquiring execution information.

4. The system according to claim 1,
wherein the server part includes a plurality of application execution parts for executing different processes, and
wherein the client part displays an interface for designating whether or not to acquire execution information for each of the plurality of application execution parts.

5. The system according to claim 1,
wherein the server part includes a plurality of application execution parts for executing different processes,
wherein a request to start acquiring execution information received by the client part includes identification information of an application execution part, and
wherein the execution information acquirement control part stores, based on identification information of an application execution part included in a request to acquire execution information received from the client part, execution information of the application execution part indicated by the identification information in the storage device.

6. The system according to claim 1,
wherein the execution information acquirement control part attaches an ID identifying an execution request for the application execution part received from the client part and stores only execution information of the application execution part related to the execution request identified by the ID in the storage device.

7. The system according to claim 1,
wherein the server part further includes a display control part for displaying the execution information stored in the storage device by the execution information acquirement control part on a display, and
wherein the display control part displays the execution information of the process executed by the application execution part on the display upon receiving a request to display the execution information stored in the storage device.

8. A recording medium storing program codes for causing a computer system to perform processes, the computer system including a client part for issuing an execution request for a process and a server part including an application execution part for executing a process according to an execution request from the client and an execution information acquirement control part for controlling acquirement of execution information, the program codes causing:
the client part to receive and store a request to start acquiring execution information;
the client part to transmit a request to acquire execution information to the server part together with an execution request based on the stored request to start acquiring execution information upon receiving the execution request for the application execution part after receiving the request to start acquiring execution information;
the application execution part to execute a process based on the execution request; and
the execution information acquirement control part to store execution information of the process executed by the application execution part in a storage device based on the request to acquire execution information.

9. The recording medium according to claim 8,
wherein the program codes causes the client part to receives a request to stop acquiring execution information,
wherein the program codes causes the client part to store the request to stop acquiring execution information,
wherein the program codes causes the client part to transmit information indicating no need to acquire execution information to the server part together with an execution request based on the request to stop acquiring execution information upon receiving each execution request for the application execution part after receiving the request to stop acquiring execution information,
wherein the program codes causes the application execution part to execute a process based on the execution request, and
wherein the program codes causes the execution information acquirement control part to perform control not to store execution information of the process executed by the application execution part in the storage device based on the information indicating no need to acquire execution information.

10. The recording medium according to claim 8,
wherein the program codes causes the client part to store an ID identifying the request to start acquiring execution information upon receiving the request to start acquiring execution information, and
wherein the program codes causes the client part to transmit a request to acquire execution information and the ID identifying the request to start acquiring to the server part together with an execution request upon receiving each execution request for the application execution part after receiving the request to start acquiring execution information.

11. The recording medium according to claim 8,
wherein the server part includes a plurality of application execution parts for executing different processes, and
wherein the program codes causes the client part to display an interface for designating whether or not to acquire execution information for each of the plurality of application execution parts on the computer system.

12. The recording medium according to claim 8,
wherein the server part includes a plurality of application execution parts for executing different processes,
wherein a request to start acquiring execution information received by the client part includes identification information of an application execution part, and
wherein the program codes causes the execution information acquirement control part to store, based on identification information of an application execution part included in a request to acquire execution information received from the client part, execution information of the application execution part indicated by the identification information in the storage device.

13. The recording medium according to claim 8,
wherein the program codes causes the execution information acquirement control part to attach an ID identifying an execution request for the application execution part received from the client part and store only execution information of the application execution part related to the execution request identified by the ID in the storage device.

14. The recording medium according to claim 8,
wherein the server part further includes a display control part for displaying the execution information stored in the storage device by the execution information acquirement control part on a display, and
wherein the program codes causes the display control part to display the execution information of the process executed by the application execution part on the display upon receiving a request to display the execution information stored in the storage device.

15. A maintenance support system for supporting maintenance by visualizing history information of a target web system, comprising:
a history information tracking key extracting part; and
a history information relationship display data acquiring part for extracting information on all call-related objects from a history of a program execution environment based on the history information tracking key.

16. The maintenance support system according to claim 15, further comprising:
request information extracted from a history of request information based on the history information tracking key; and
a history information relationship display part for displaying information on all the call-related objects extracted from the history of the program execution environment based on the history information tracking key.

17. The maintenance support system according to claim 15,
wherein the history information relationship display data acquiring part extracts information on accesses to a database from a history of a database connection API set for object-oriented language based on the history information tracking key.

18. The maintenance support system according to claim 15, further comprising a history information relationship display part for displaying, based on the history information tracking key, information relating to client/system operations and extracted from a history of the client/system operations, information relating to all call-related objects starting from a specific object and extracted from the history of the program execution environment, and information relating to accesses to a database and extracted from a history of a database connection API set for object-oriented language.
